(19) United States
(12) Patent Application Publication
(10) Pub. No.: US 2023/0135880 A1
(43) Pub. Date: May 4, 2023

(54) TEXT RECOGNITION METHOD AND APPARATUS

(71) Applicant: SAMSUNG SDS CO., LTD., Seoul (KR)

(72) Inventors: Sunghak SONG, Seoul (KR); Namwook KIM, Seoul (KR); Hyoseob SONG, Seoul (KR); Seongho JOE, Seoul (KR); Youngjune GWON, Seoul (KR)

(73) Assignee: SAMSUNG SDS CO., LTD., Seoul (KR)

(21) Appl. No.: 17/976,240

(22) Filed: Oct. 28, 2022

(30) Foreign Application Priority Data
Oct. 29, 2021 (KR) 10-2021-0147288

(51) Int. Cl. G06V 30/26; G06V 30/19; G06V 30/14

(52) U.S. Cl. CPC G06V 30/26; G06V 30/19147; G06V 30/19173; G06V 30/1448

(57) ABSTRACT

Disclosed is a text recognition method and apparatus. A text recognition post-processing method for reflecting user post-correction performed by a processor in an apparatus, the text recognition post-processing method includes training a deep learning post-processing model based on post-correction data comprising a partial image including post-correction target text and post-correction text when there is user post-correction for a text recognition result of an input image; and post-processing a text recognition result of another input image by applying the trained deep learning post-processing model.

### CROSS-REFERENCE TO RELATED APPLICATION(S)

This application is based on and claims priority under 35 U.S.C. 119 to Korean Patent Application No. 10-2021-0147288, filed on Oct. 29, 2021, in the Korean Intellectual Property Office, the disclosure of which is herein incorporated by reference in its entirety.

### BACKGROUND OF THE INVENTION

### 1. Field of the Invention

The present disclosure relates to a text recognition method and apparatus and, more particularly, to a text recognition method and apparatus which can automatically reflect user post-correction feedback to training, thereby automatically post-correcting OCR recognition results with respect to similar patterns thereafter.

### 2. Description of the Prior Art

In the conventional optical character reader (OCR) recognition technology, as shown in FIG. 1, in general, text is recognized using regular expression or edit distance-based word matching with reference to a word dictionary, and when an OCR false positive occurs after the text recognition result, a user corrects the word dictionary and performs subsequent text recognition by referring to the word dictionary in which a user post-correction feedback is reflected.

In the conventional user post-correction feedback method, the user corrects the OCR recognition result in the word dictionary and then reflects the correction result as it is to perform subsequent text recognition. That is, the conventional user post-correction feedback method is a method in which the recognition result is not continuously reflected unless there is a user's correction even if subsequent text recognition is performed, or a method in which the user corrects the word dictionary according to the OCR recognition result so that, when the same OCR misrecognition result is repeated even after correction, post-processing proceeds in a manner that a corresponding output result is correctly changed one by one in the word dictionary.

However, the conventional OCR recognition technology applying such a user post-correction feedback method has a problem that OCR false positives may occur in the same form in similar text recognition according to the limitations of the word dictionary even in OCR recognition after the user correction is made. In addition, since the user's corrections are simply stored in the word dictionary and the word dictionary is further corrected when the same false positive is repeated thereafter, when the recognition result is not consistent as the quality or shape of the document changes, the user's post-correction effect is not immediately reflected and continuously causes false positives.

### SUMMARY OF THE INVENTION

As described above, the existing user post-correction feedback method is performed in a passive manner in which the OCR recognition result is manually reflected and matched in the word dictionary stored by the user. Accordingly, this disclosure has been made in order to solve the above-mentioned problems in the prior art and an aspect of the disclosure is to provide a text recognition method and apparatus that can train and reflect user post-correction feedback through a deep learning model, so that the deep learning model can automatically and accurately perform correction processing with respect to a similar false positive pattern thereafter.

Another aspect of the present disclosure is to provide a text recognition method and apparatus that can utilize the user post-correction result as additional learning data by reflecting not only the similarity of words but also the characteristics of words and images by convergence of text embedding and image embedding.

In addition, in the post-correction processing of the existing word dictionary method, as a predetermined post-correction result is returned, there is a disadvantage in that the post-correction result does not work properly when it deviates from the predetermined post-correction pattern thereafter. Here, another aspect of the disclosure is to provide a text recognition method and apparatus in which the post-correction result is reflected through a learning model even in a portion where the post-correction pattern is changed through a fused embedding model of text embedding and image embedding while the user's post-correction result is used as additional learning data, thereby improving post-correction accuracy.

In accordance with a first aspect of the disclosure, there is provided a text recognition post-processing method for reflecting user post-correction performed by a processor in an apparatus, the text recognition post-processing method including training a deep learning post-processing model based on post-correction data comprising a partial image including a post-correction target text and a post-correction text when there is user post-correction for a text recognition result of an input image; and post-processing a text recognition result of another input image by applying the trained deep learning post-processing model.

The training of the deep learning post-processing model may include collecting the post-correction data, and the post-correction data may further include at least one of a recognition result text, a bounding box coordinate of the partial image, a document classification value, and the input image.

The training of the deep learning post-processing model may include performing data labeling for training based on the post-correction data.

The training of the deep learning post-processing model may include collecting a plurality of pieces of user post-correction data in a storage; and performing data augmentation for additional generation of learning data based on the collected plurality of pieces of user post-correction data.

The training of the deep learning post-processing model may include training the deep learning post-processing model when the number of the collected plurality of pieces of user post-correction data is greater than or equal to a threshold value.

The training of the deep learning post-processing model may include embedding the partial image, embedding the post-correction text, and training the deep learning post-processing model by combining an embedded result of the partial image and an embedded result of the post-correction text.

The text recognition post-processing method may further include, after the training of the deep learning post-processing model, additionally training the deep learning post-processing model when text recognition accuracy is less than a threshold value based on a predetermined test set.

In accordance with a second aspect of the disclosure, there is provided a computer program stored in a medium in combination with hardware to perform the text recognition method.

In accordance with a third aspect of the disclosure, there is provided a text recognition apparatus with a processor, the text recognition apparatus including a memory configured to be coupled to the processor and to have one or more modules configured to be executed by the processor, wherein the one or more modules include instructions that cause the text recognition apparatus to perform operations of: training a deep learning post-processing model based on post-correction data comprising a partial image including a post-correction target text and a post-correction text when there is user post-correction for a text recognition result of an input image to perform text recognition post-processing for reflecting user post-correction; and post-processing a text recognition result of another input image by applying the trained deep learning post-processing model.

The one or more modules may further include an instruction that causes the text recognition apparatus to perform an operation of collecting the post-correction data to train the deep learning post-processing model, and the post-correction data may further include at least one of a recognition result text, a bounding box coordinate of the partial image, a document classification value, and the input image.

The one or more modules may further include an instruction that causes the text recognition apparatus to perform an operation of performing data labeling for training based on the post-correction data when training the deep learning post-processing model.

The one or more modules may further include an instruction that causes the text recognition apparatus to perform operations of: collecting a plurality of pieces of user post-correction data in a storage when training the deep learning post-processing model; and performing data augmentation for additional generation of learning data based on the collected plurality of pieces of user post-correction data.

The one or more modules may further include an instruction that causes the text recognition apparatus to perform an operation of training the deep learning post-processing model when the number of the collected plurality of pieces of user post-correction data is greater than or equal to a threshold value when training the deep learning post-processing model.

The one or more modules may further include, when training the deep learning post-processing model, an instruction that causes the text recognition apparatus to perform operations of: embedding the partial image; embedding the post-correction text; and training the deep learning post-processing model by combining an embedded result of the partial image and an embedded result of the post-correction text.

The one or more modules may further include, after training the deep learning post-processing model, an instruction that causes the text recognition apparatus to perform an operation of additionally training the deep learning post-processing model when text recognition accuracy is less than a threshold value based on a predetermined test set.

In accordance with a fourth aspect of the disclosure, there is provided a computer-readable storage medium storing instructions that, when executed by a processor, cause an apparatus including the processor to perform operations for text recognition post-processing for reflecting user post-correction, the operations of: training a deep learning post-processing model based on post-correction data comprising a partial image including a post-correction target text and a post-correction text when there is user post-correction for a text recognition result of an input image; and post-processing a text recognition result of another input image by applying the trained deep learning post-processing model.

The training of the deep learning post-processing model may include collecting the post-correction data, and the post-correction data may further include at least one of a recognition result text, a bounding box coordinate of the partial image, a document classification value, and the input image.

The training of the deep learning post-processing model may include performing data labeling for training based on the post-correction data.

The training of the deep learning post-processing model may include collecting a plurality of pieces of user post-correction data in a storage; and performing data augmentation for additional generation of learning data based on the collected plurality of pieces of user post-correction data.

The training of the deep learning post-processing model may include training the deep learning post-processing model when the number of the collected plurality of pieces of user post-correction data is greater than or equal to a threshold value.

The operation may further include, after the training of the deep learning post-processing model, additionally training the deep learning post-processing model when text recognition accuracy is less than a threshold value based on a predetermined test set.

According to the text recognition method and apparatus according to the disclosure, it is possible to train and reflect user post-correction feedback through a deep learning model, and accordingly, the deep learning model can automatically and accurately perform correction processing with respect to a similar false positive pattern thereafter.

In addition, according to the text recognition method and apparatus according to the disclosure, it is possible to utilize the user post-correction result as additional learning data by reflecting not only the similarity of words but also the characteristics of words and images by convergence of text embedding and image embedding.

In addition, according to the text recognition method and apparatus according to the disclosure, the post-correction result is reflected through a learning model even in a portion where the post-correction pattern is changed, through a fused embedding model of text embedding and image embedding while the user's post-correction result is used as additional learning data, thereby improving post-correction accuracy.

### BRIEF DESCRIPTION OF THE DRAWINGS

In order to help understanding of the disclosure, the accompanying drawings which are included as a part of the detailed description provide embodiments of the disclosure and describe the technical features of the disclosure together with the detailed description.

FIG. 1 is a diagram illustrating user post-correction feedback in a conventional text recognition technology.

FIG. 2 is a diagram illustrating a concept of a training process for reflecting user post-correction data of a text recognition system according to an embodiment of the disclosure.

FIG. 3 is a flowchart illustrating a process of generating user post-correction data in a text recognition system according to an embodiment of the disclosure.

FIG. 4 is a diagram illustrating a text recognition post-processing apparatus according to an embodiment of the disclosure.

FIG. 5 is a flowchart illustrating a concept of a method of generating learning data for reflecting user post-correction data in a text recognition system according to an embodiment of the disclosure.

FIG. 6 is a flowchart illustrating collection of user post-correction data in a text recognition system according to an embodiment of the disclosure.

FIG. 7 is a flowchart illustrating a subsequent process of FIG. 6.

FIG. 8 is a flowchart illustrating a process of training user post-correction data and applying a training result in a text recognition system operated according to an embodiment of the disclosure.

FIG. 9 is an example of characters in a general document image.

FIG. 10 illustrates a device to which the proposed method of the disclosure can be applied.

### DETAILED DESCRIPTION OF THE EXEMPLARY EMBODIMENTS

Hereinafter, embodiments disclosed herein will be described in detail with reference to the accompanying drawings. The objects, specific advantages, and novel features of the disclosure will become more apparent from the following detailed description and preferred embodiments taken in conjunction with the accompanying drawings.

Prior to this, the terms or words used in the present specification and claims should be interpreted as meanings and concepts consistent with the technical spirit of the disclosure as the inventors appropriately defined the concepts in order to explain their invention in the best way are merely for describing the embodiments, and should not be construed as limiting the present invention.

In assigning reference numerals to the components, the same or similar components are given the same reference numerals regardless of the reference numerals, and a redundant description thereof will be omitted. The suffixes “module” and “part” for the components used in the following description are given or mixed in consideration of the ease of writing the specification, and do not have a meaning or role distinct from each other by themselves, and may mean the software or hardware configuration element.

In describing the components of the present invention, when a component is expressed in a singular form, it should be understood that the component also includes a plural form unless otherwise specified. Also, terms such as “first”, “second”, etc., are used to distinguish one component from another, and the components are not limited by the terms. In addition, when a component is connected to another component, it means that another component may be connected between the component and the other component.

In addition, in describing the embodiments disclosed in the present specification, if it is determined that detailed descriptions of related known technologies may obscure the gist of the embodiments disclosed in the present specification, the detailed description thereof will be omitted. In addition, the accompanying drawings are only for easy understanding of the embodiments disclosed in the present specification, and the technical spirit disclosed herein is not limited by the accompanying drawings, and all changes included in the spirit and scope of the disclosure, should be understood to include equivalents or substitutes.

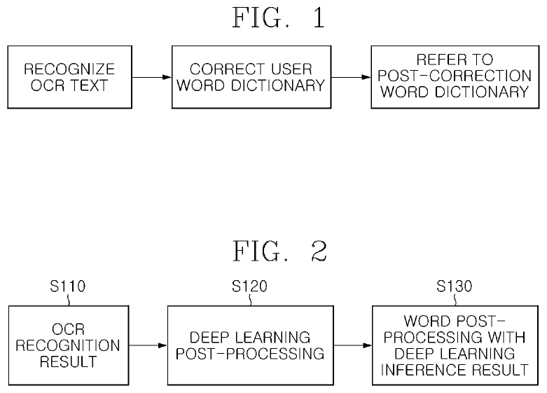

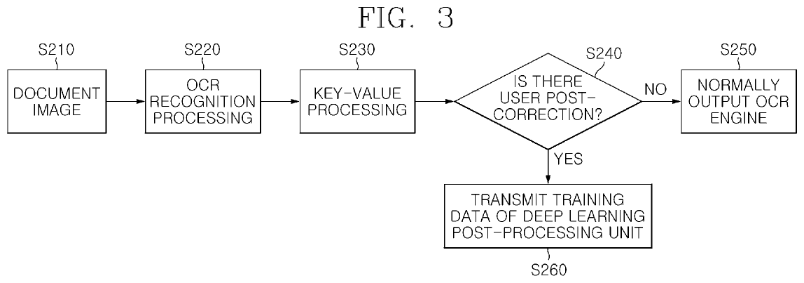

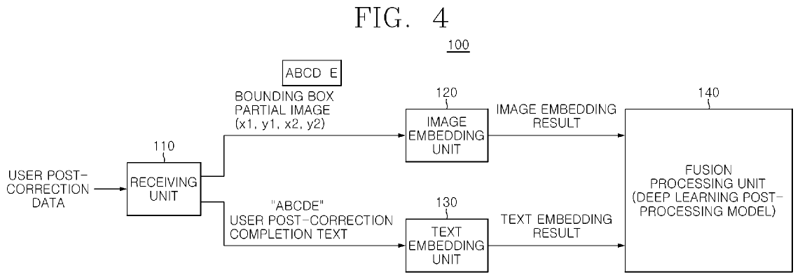

In an embodiment of the disclosure, operations shown in FIGS. 2 to 3 and FIGS. 5 to 8 process the processes of the character recognition method mentioned in FIGS. 4 and/or 10, and the description related to these drawings, which will be described later. It should be clarified in advance that it may be performed by the character recognition post-processing device or the character recognition device 1000.

FIG. 2 is a diagram illustrating a concept of a training process for reflecting user post-correction data of a text recognition system according to an embodiment of the disclosure. In addition, FIG. 4 is a diagram illustrating a text recognition post-processing apparatus according to an embodiment of the disclosure.

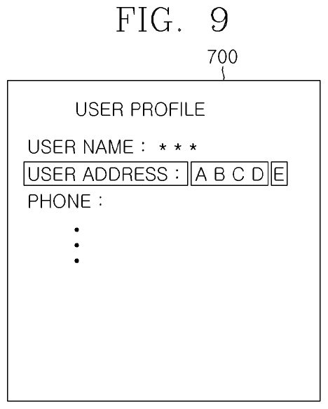

Referring to FIGS. 2 and 4, as will be described below, a text recognition system including a text recognition post-processing apparatus 100 (or text recognition apparatus) according to the disclosure performs optical character reader (OCR) recognition on characters included in a document based on image processing or the like for an electronic document (image) (hereinafter referred to as a document) 700 input as shown in FIG. 9, and collects user post-correction data in operation S110, such as user post-correction feedback, that is, a misrecognized post-correction target character and post-correction text, in which the corresponding feedback is performed when the user corrects the misrecognized post-correction target character, a partial image corresponding to a bounding box of the misrecognized post-correction target character, and the like.

The collected user post-correction data is transmitted to the text recognition post-processing apparatus 100 of the disclosure, and the text recognition post-processing apparatus 100 trains and reflects the user post-correction data fed back in this way through the deep learning model of the disclosure in operation S120. Accordingly, the text recognition post-processing apparatus 100 of the text recognition system operated thereafter reflects an inference result by the deep learning model so that the deep learning model can automatically and accurately perform correction processing on a false positive pattern similar to the misrecognized post-correction target character (or word) in operation S130.

FIG. 3 is a flowchart illustrating a process of generating user post-correction data in a text recognition system according to an embodiment of the disclosure.

Referring to FIG. 3, when a document is input in operation S210, the text recognition system of the disclosure performs OCR recognition on characters included in the document based on image processing using an OCR engine in operation S220. For the text recognition result, the text recognition system of the disclosure generates a feature map for information on feature points of the document, inputs feature point pairs corresponding to the recognized characters into a predetermined relational inference neural network so that a key-value relationship (e.g., user address (K1)-ABCD(V1) E(V2), etc., in FIG. 9) between the recognized characters may be processed in operation S230.

When there is no user post-correction for the processing result in operation S240, the text recognition result of the OCR engine is normally output in operation S250. When there is a character misrecognition with respect to the key-value relationship processing result, the user performs post-correction. For example, in the above example, as “ABCDE” is misrecognized as “ABCD E”, when the text recognition result is misrecognized as “user address: ABCD”, the user corrects “ABCD E” into “ABCDE” so that the correct text recognition result as ground truth data such as “user address: ABCDE” comes out. In this way, when there is a user's post-correction, in addition to the post-correction text “ABCDE” and the partial image corresponding to the bounding box of the misrecognized post-correction target character, if necessary, as will be described below, user post-correction data such as the recognition result text, that is, the misrecognized post-correction target character “ABCD E”, a document classification value, an original image of the target document, bounding box coordinates of the misrecognized post-correction target character, etc., is transmitted to the text recognition post-processing apparatus 100 of the disclosure as shown in FIG. 4, so that deep learning training may be performed in operation S260.

As will be described below, in the text recognition post-processing apparatus 100 of the disclosure, the user post-correction result may be used as additional learning data by reflecting not only the similarity of words but also the characteristics of words and images by convergence of text embedding and image embedding. Accordingly, the post-correction result is reflected through the learning model even in a portion where the post-correction pattern is changed through a fused embedding model of text embedding and image embedding while the user's post-correction result is used as the additional learning data, thereby improving post-correction accuracy.

FIG. 4 is a diagram illustrating the text recognition post-processing apparatus 100 according to an embodiment of the disclosure.

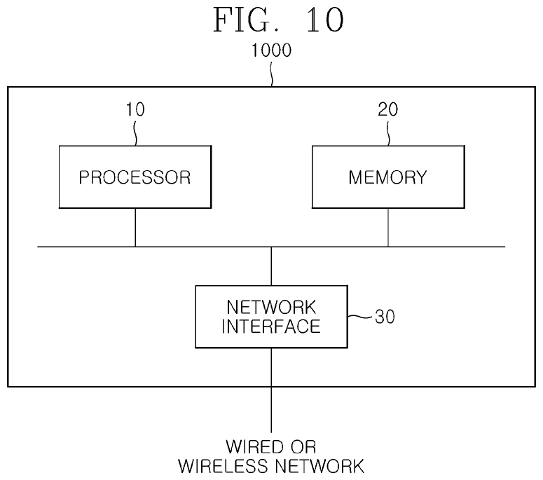

Referring to FIG. 4, the text recognition post-processing apparatus 100 according to an embodiment of the disclosure includes a receiving unit 110, an image embedding unit 120, a character embedding unit 130, and a fusion processing unit 140. Each component of the text recognition post-processing apparatus 100 may be implemented to be performed by a semiconductor processor, application software, or a combination thereof (see FIG. 10).

The receiving unit 110 receives user post-correction data when there is a user's post-correction for the key-value relationship processing result as shown in FIG. 3 in the text recognition system of the disclosure. As the user post-correction data, one or more pieces of post-corrected data included in the document for various documents (e.g., receipt, invoice, user profile, etc.) may be accumulated in a predetermined storage such as a memory and may be input to the receiving unit 110. The post-correction data includes a partial image corresponding to the corresponding bounding box including a misrecognized post-correction target character (e.g., “ABCD E” in the example of FIG. 9), and a post-correction text (e.g., “ABCDE” in the example of FIG. 9). In addition, as will be described below, recognition result text, a document classification value (e.g., receipt, invoice, user profile, etc.), an original image of a target document, bounding box coordinates of the misrecognized post-correction target character, etc., may be included in the user post-correction data for further reference.

The image embedding unit 120 performs image embedding processing on the partial image corresponding to the bounding box of the misrecognized post-correction target character (e.g., “ABCD E”). In the image embedding processing, the corresponding partial image is vectorized using a predetermined image embedding algorithm.

The character embedding unit 130 performs character embedding on the post-correction text (e.g., “ABCDE”) for the misrecognized post-correction target character. In the character embedding processing, the corresponding post-correction text is vectorized using a predetermined character embedding algorithm such as one-hot vector or word2vec. The post-correction text may include one letter, a word of two or more letters, a sentence, and the like.

The fusion processing unit 140 may match the image embedding processing result (vector) and the text embedding processing result (vector) and combine them to train a deep learning post-processing model. For example, a neural network is trained so that the post-correction text (e.g., “ABCDE”) is inferred from the partial image of the misrecognized post-correction target character (e.g., “ABCD E”). Here, as the neural network for training the deep learning post-processing model, for example, a convolutional neural network (CNN), a recurrent neural network (RNN), a generative adversarial network (GAN), etc., may be used.

When data such as recognition result text, a document classification value (e.g., receipt, invoice, user profile, etc.), an original image of a target document, bounding box coordinates of the misrecognized post-correction target character (e.g., upper-left and lower-right coordinates {x1, y1, x2, and y2}), or the like is included in the user post-correction data, the fusion processing unit 140 further fuses one or more of the above-mentioned data and refers to them correspondingly to train the neural network so that the post-correction text (e.g., “ABCDE”) is inferred with respect to the partial image of the misrecognized post-correction target character (e.g., “ABCD E”). In addition, for example, according to the document classification value (e.g., receipt, invoice, user profile, etc.), it is possible to configure specific data to have attention during training. In addition, by referring to the original image of the target document itself during the training process, training may be performed so that the post-correction text (e.g., “ABCDE”) is inferred from the misrecognized post-correction target character (e.g., “ABCD E”). In addition, during training, the location of the bounding box coordinates (e.g., upper-left and lower-right coordinates {x1, y1, x2, and y2}) of the post-correction target character misrecognized in relation to the original image of the target document may be referred to.

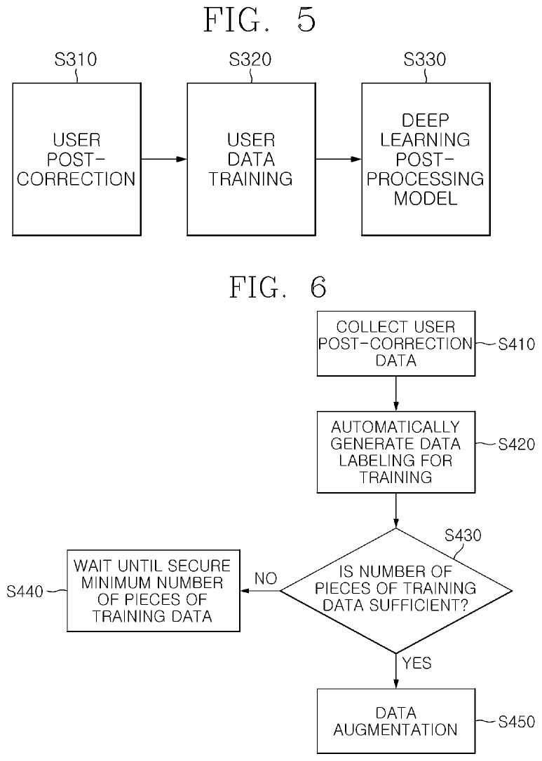

FIG. 5 is a flowchart illustrating a concept of a method of generating learning data for reflecting user post-correction data in a text recognition system according to an embodiment of the disclosure.

Referring to FIG. 5, as shown in FIG. 3, when there is a user post-correction for a result obtained by performing text recognition on an input image such as a document using the OCR engine in the text recognition system of the disclosure in operation S310, the user post-correction data is transmitted to the text recognition post-processing apparatus 100 of the disclosure as shown in FIG. 4 to perform deep learning training in operation S320. That is, the text recognition post-processing apparatus 100 may train the deep learning post-processing model based on the post-correction data comprising the partial image including the post-correction target character and the post-correction text.

As to accumulation of the user post-correction data, one or more pieces of post-corrected data included in a document for various documents (e.g., receipts, invoices, user profiles, etc.) may be accumulated in a predetermined storage such as a memory, for example, with a predetermined data size or for a predetermined period of time, and may be input to the receiving unit 110 of the text recognition post-processing apparatus 100 of FIG. 4. The text recognition post-processing apparatus 100 may post-process the text recognition result of another input image by applying the trained deep learning post-processing model in operation S330.

FIG. 6 is a flowchart illustrating collection of user post-correction data in a text recognition system according to an embodiment of the disclosure.

Referring to FIG. 6, as shown in FIG. 3, when there is a user post-correction for the result obtained by performing text recognition using the OCR engine in the text recognition system of the disclosure, the user post-correction data, that is, the partial image corresponding to the corresponding bounding box including the misrecognized post-correction target character, and the post-correction text (e.g., “ABCDE” in the example of FIG. 9) are collected in a predetermined storage such as a memory in operation S410. In addition, the user post-correction data may further include data such as recognition result text (e.g., “ABCD E” in the example of FIG. 9) and a document classification value, an input image that is an original image of a target document, and bounding box coordinates of a misrecognized post-correction target character (e.g., left, top, right, bottom coordinates {x1, y1, x2, and y2}).

The text recognition system of the disclosure may perform data labeling for training based on the user post-correction data collected as described above in operation S420. For example, corresponding labeling data may be generated to correspond to corresponding items such as the recognition result text, the post-correction text, the document classification value (e.g., receipt, invoice, user profile, etc.), the original image of the target document, and the bounding box coordinates of the misrecognized post-correction target character, and may be stored in a storage.

In order to train the deep learning post-processing model, the text recognition system of the disclosure may store such user post-correction data in the storage, and may accumulate a plurality of pieces of post-correction data for various documents (e.g., receipts, invoices, user profiles, etc.), for example, with a predetermined data size or for a predetermined period (e.g., 1000 pieces, etc.) in operations S430 and S440.

When the plurality of pieces of post-correction data are sufficiently stored in the storage above a threshold value, in order to train the deep learning post-processing model, the text recognition system of the disclosure may perform data augmentation for additional generation of learning data based on the collected plurality of pieces of user post-correction data in operation S450. That is, the user post-correction data stored in the storage may be utilized as data augmentation information to be post-processed and trained in the text recognition post-processing apparatus 100 of FIG. 4.

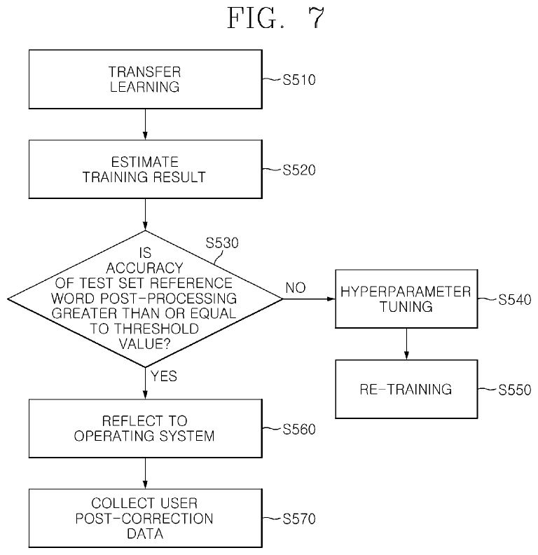

FIG. 7 is a flowchart illustrating a subsequent process of FIG. 6.

Referring to FIG. 7, the text recognition system of the disclosure may receive data augmentation result to be post-processed and trained, which is stored in the storage, and may perform post-processing learning on the user post-correction data included in the received data augmentation result through a transfer learning in operation S510. For example, in the text recognition post-processing apparatus 100 of FIG. 4, post-processing learning may be performed through the transfer learning using the neural network as described above so that the deep learning post-processing model can be trained according to various types such as receipts, invoices, user profiles, etc.

The result of such post-processing learning is evaluated by recognition accuracy in operation S520. Here, the recognition accuracy can be evaluated using a test set. The test set may be configured to include an image in which the user has post-corrected an error, that is, a partial image of the above-described user post-correction data, and may be configured to include other various sample images.

For example, in the text recognition system of the disclosure, the recognition accuracy (e.g., the number of correctly recognized images/the total number of images) of characters for images in the test set (e.g., one letter, two or more words, sentences, etc.) is less than a threshold value in operation S530, it may be determined to additionally perform (re-training) the post-processing learning of the deep learning post-processing model in operations S540 and S550. Such re-training may be performed after previously configuring hyperparameters such as loss and batch size to be tuned.

According to the evaluation result of the post-processing learning, when the text recognition accuracy as described above is greater than or equal to the threshold value, the text recognition system of the disclosure applies the post-processing training result to the text recognition system in operation S560, and even after that, in the case of a new document or the like, user post-processing data may be collected due to less accuracy of text recognition, that is, the user post-correction data may be further collected to further improve the accuracy through additional learning in operation S570.

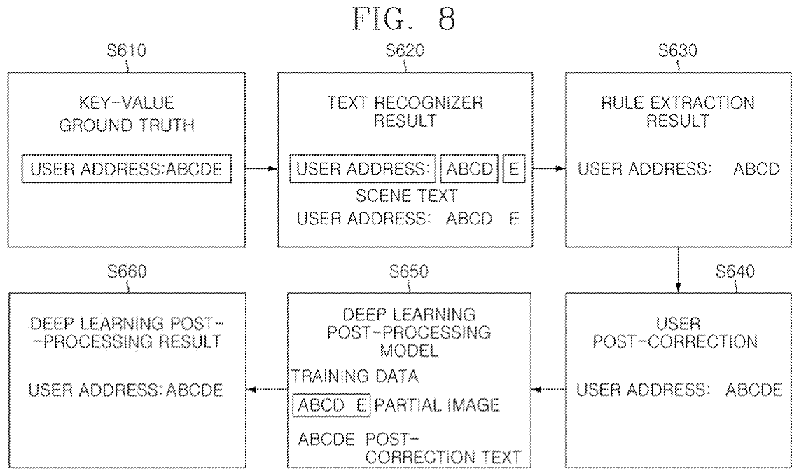

Hereinafter, a process of training and applying user post-correction data in the text recognition system operated according to an embodiment of the disclosure will be further described with reference to FIGS. 8 and 9.

FIG. 8 is a flowchart illustrating a process of training user post-correction data and applying a training result in a text recognition system operated according to an embodiment of the disclosure.

As exemplarily shown in FIG. 8, when the key-value relationship to be actually obtained as ground truth data is the user address (K)-ABCDE (V) in operation S610, the recognition result text (Scene Text) may be obtained as “ABCD E” in operation S620 according to misrecognition due to other reasons such as a poor image state.

At this time, the key-value extraction result according to the general rule may be obtained as “user address: ABCD” according to the space between ABCD and E in operation S630. Since such a result is an error, the user corrects the key-value extraction result to “user address: ABCDE” through post-correction in operation S640.

The deep learning post-processing model may be trained based on the post-correction data including the user's post-correction text and the partial image including the post-correction target character in operation S650, so that the trained deep learning post-processing model may automatically correct the misrecognition in operation S660 and the corrected misrecognition may be applied to text recognition result post-processing of a similar type of another input image.

The deep learning post-processing model in the text recognition system according to an embodiment of the disclosure may be included in an OCR recognizer model or configured as a model separate therefrom.

As described above, in the text recognition apparatus 100 and the text recognition system including the same according to the disclosure, the user's post-correction feedback can be trained and reflected in the deep learning model, and accordingly, the deep learning model can automatically perform post-correction with respect to a similar false positive pattern thereafter. In addition, it is possible to utilize the user post-correction result as additional learning data by reflecting not only the similarity of words but also the characteristics of words and images by convergence of text embedding and image embedding. Accordingly, the post-correction result is reflected through a learning model even in a portion where the post-correction pattern is changed, through a fused embedding model of text embedding and image embedding while the user's post-correction result is used as additional learning data, thereby improving post-correction accuracy.

In addition, the text recognition apparatus 100 or the character recognition system including the same according to an embodiment of the disclosure can be implemented as a computer-readable code in a medium in which a program is recorded. The computer-readable medium may continuously store a computer-executable program, or may be temporarily stored for execution or download. In addition, the medium may be a variety of recording means or storage means in the form of a single or a plurality of hardware combined, it is not limited to a medium directly connected to any computer system, and may exist distributed on a network. Accordingly, the above detailed description should not be construed as restrictive in all respects but as exemplary. The scope of the disclosure should be determined by a reasonable interpretation of the appended claims, and all modifications within the equivalent scope of the disclosure are included in the scope of the disclosure.

The disclosure is not limited by the above-described embodiments and the accompanying drawings, but may be implemented in other specific forms. For those of ordinary skill in the art to which the disclosure pertains, it will be apparent that the components according to the disclosure can be substituted, modified, and changed without departing from the technical spirit of the disclosure.

For example, the method, function, or algorithm performed in the text recognition apparatus 100 or the text recognition system including the same according to an embodiment of the disclosure may be implemented to be performed by a computer program combined with the hardware and stored in the medium.

In addition, for example, the text recognition system of the disclosure may be implemented to include a computing device including a processor and a memory coupled to the processor. The memory includes one or more modules configured to include instructions to be executed by the processor. For example, when the processor controls the operation of the modules and there is a user's post-correction on the character recognition result of the input image by the command, the deep learning post-processing model may be trained based on the post-correction data including the partial image including the post-correction target character and the post-correction text, and the text recognition result of the other input image may be controlled to be post-processed by applying the trained deep learning post-processing model.

FIG. 10 illustrates a device 1000 to which the proposed method of the disclosure can be applied.

Referring to FIG. 10, the device 1000 may be configured to implement a text recognition process according to the proposed method of the disclosure. As an example, the device 1000 may be a server device 1000 that provides a text recognition service.

For example, the device 1000 to which the proposed method of the disclosure can be applied may include a network device such as a repeater, a hub, a bridge, a switch, a router, a gateway, and the like, a computer device such as a desktop computer, a workstation, and the like, a mobile terminal such as a smartphone, a portable device such as a laptop computer, home appliances such as a digital TV, and transportation means such as automobiles. As another example, the device 1000 to which the disclosure can be applied may be included as a part of an application specific integrated circuit (ASIC) implemented in the form of a system on chip (SoC).

The memory 20 may be connected to the processor 10 during operation, and may store programs and/or instructions for processing and controlling the processor 10 and may store data and information used in the present invention, control information necessary for data and information processing according to the present invention, and temporary data generated during data and information processing.

The memory 20 may be implemented as a storage device such as read only memory (ROM), random access memory (RAM), erasable programmable read only memory (EPROM), electrically erasable programmable read-only memory (EEPROM), flash memory, static RAM (SRAM), hard disk drive (HDD), and the like.

The processor 10 may be operatively connected to the memory 20 and/or the network interface 30, and controls the operation of each module in the device 1000. In particular, the processor 10 may perform various control functions for performing the proposed method of the present invention. The processor 10 may also be referred to as a controller, a microcontroller, a microprocessor, a microcomputer, or the like. The proposed method of the disclosure may be implemented by hardware or firmware, software, or a combination thereof. When the disclosure is implemented using hardware, an application specific integrated circuit (ASIC) or digital signal processor (DSP), digital signal processing device (DSPD), programmable logic device (PLD), programmable logic device (FPLD), and field programmable gate array (FPGA) may be provided in the processor 10. Meanwhile, when the proposed method of the disclosure is implemented using firmware or software, the firmware or the software may include instructions related to modules, procedures, or functions that perform functions or operations necessary to implement the proposed method of the present invention. The instructions are stored in the memory 20 or stored in a computer-readable recording medium (not shown) separately from the memory 20 so that the device 1000 is configured to implement the proposed method of the disclosure when executed by the processor 10.

In addition, the device 1000 may include a network interface device 30. The network interface device 30 is connected to the processor 10 during operation, and the processor 10 may control the network interface device 30 to transmit or receive wireless/wired signals carrying information and/or data, signals, messages, etc., through a wireless/wired network. The network interface device 30 supports various communication standards such as, for example, IEEE 802 series, 3GPP LTE(-A), 3GPP 5G, and the like, and may transmit/receive control information and/or data signals according to the corresponding communication standards. The network interface device 30 may be implemented outside the device 1000 as needed.

What is claimed is:

1. A text recognition post-processing method for reflecting user post-correction, the text recognition post-processing method being performed by a processor in an apparatus and comprising:
training a deep learning post-processing model based on post-correction data comprising a partial image including a post-correction target text and a post-correction text when there is user post-correction for a text recognition result of an input image; and
post-processing a text recognition result of another input image by applying the trained deep learning post-processing model.

2. The text recognition post-processing method of claim 1, wherein the training of the deep learning post-processing model comprises collecting the post-correction data, and the post-correction data further comprises at least one of a recognition result text, a bounding box coordinate of the partial image, a document classification value, and the input image.

3. The text recognition post-processing method of claim 1, wherein the training of the deep learning post-processing model comprises performing data labeling for training based on the post-correction data.

4. The text recognition post-processing method of claim 1, wherein the training of the deep learning post-processing model comprises:
collecting a plurality of pieces of user post-correction data in a storage; and
performing data augmentation for additional generation of learning data based on the collected plurality of pieces of user post-correction data.

5. The text recognition post-processing method of claim 4, wherein the training of the deep learning post-processing model comprises training the deep learning post-processing model when the number of the collected pieces of user post-correction data is greater than or equal to a threshold value.

6. The text recognition post-processing method of claim 1, wherein the training of the deep learning post-processing model comprises:
embedding the partial image;
embedding the post-correction text; and
training the deep learning post-processing model by combining an embedded result of the partial image and an embedded result of the post-correction text.

7. The text recognition post-processing method of claim 1, further comprising, after the training of the deep learning post-processing model, additionally training the deep learning post-processing model when text recognition accuracy is less than a threshold value based on a predetermined test set.

8. A text recognition apparatus with a processor, the text recognition apparatus comprising a memory coupled to the processor,
wherein the memory comprises one or more modules configured to be executed by the processor, and
the one or more modules comprise instructions that cause the text recognition apparatus to perform:
in order to perform text recognition post-processing for reflecting user post-correction,
training a deep learning post-processing model based on post-correction data comprising a partial image including a post-correction target text and a post-correction text when there is user post-correction for a text recognition result of an input image; and
post-processing a text recognition result of another input image by applying the trained deep learning post-processing model.

9. The text recognition apparatus of claim 8, wherein the one or more modules further comprise an instruction that causes the text recognition apparatus to perform collecting the post-correction data to train the deep learning post-processing model, and
the post-correction data further comprises at least one of a recognition result text, a bounding box coordinate of the partial image, a document classification value, and the input image.

10. The text recognition apparatus of claim 8, wherein the one or more modules further comprise an instruction that causes the text recognition apparatus to perform performing data labeling for training based on the post-correction data when training the deep learning post-processing model.

11. The text recognition apparatus of claim 8, wherein the one or more modules further comprise an instruction that causes the text recognition apparatus to perform:
collecting a plurality of pieces of user post-correction data in a storage when training the deep learning post-processing model; and
performing data augmentation for additional generation of learning data based on the collected plurality of pieces of user post-correction data.

12. The text recognition apparatus of claim 11, wherein the one or more modules further comprise an instruction that causes the text recognition apparatus to perform training the deep learning post-processing model when the number of the collected plurality of pieces of user post-correction data is greater than or equal to a threshold value when training the deep learning post-processing model.

13. The text recognition apparatus of claim 11, wherein the one or more modules further comprise, when training the deep learning post-processing model, an instruction that causes the text recognition apparatus to perform:
embedding the partial image;
embedding the post-correction text; and
training the deep learning post-processing model by combining an embedded result of the partial image and an embedded result of the post-correction text.

14. The text recognition apparatus of claim 11, wherein the one or more modules further comprise, after training the deep learning post-processing model, an instruction that causes the text recognition apparatus to perform additionally training the deep learning post-processing model when text recognition accuracy is less than a threshold value based on a predetermined test set.

15. A computer-readable storage medium storing instructions that, when executed by a processor, cause an apparatus comprising the processor to perform operations for text recognition post-processing for reflecting user post-correction, the operations comprising:
training a deep learning post-processing model based on post-correction data comprising a partial image including a post-correction target text and a post-correction text when there is user post-correction for a text recognition result of an input image; and
post-processing a text recognition result of another input image by applying the trained deep learning post-processing model.

16. The computer-readable storage medium of claim 15, wherein the training of the deep learning post-processing model comprises collecting the post-correction data, and
the post-correction data further comprises at least one of a recognition result text, a bounding box coordinate of the partial image, a document classification value, and the input image.

17. The computer-readable storage medium of claim 15, wherein the training of the deep learning post-processing model comprises performing data labeling for training based on the post-correction data.

18. The computer-readable storage medium of claim 15, wherein the training of the deep learning post-processing model comprises:
collecting a plurality of pieces of user post-correction data in a storage; and
performing data augmentation for additional generation of learning data based on the collected plurality of pieces of user post-correction data.

19. The computer-readable storage medium of claim 15, wherein the training of the deep learning post-processing model comprises:
embedding the partial image;
embedding the post-correction text; and
training the deep learning post-processing model by combining an embedded result of the partial image and an embedded result of the post-correction text.

20. The computer-readable storage medium of claim 15, wherein the operations further comprise, after the training of the deep learning post-processing model, additionally training the deep learning post-processing model when text recognition accuracy is less than a threshold value based on a predetermined test set.
